(19) United States
(12) Patent Application Publication
(10) Pub. No.: US 2009/0028030 A1
(43) Pub. Date: Jan. 29, 2009

(54) Apparatus and Method for Driving Optical Disc and Optical Disc Recording Apparatus

(75) Inventor: Kouhei Suzuki, Saitama (JP)

Correspondence Address: YOUNG & THOMPSON, 209 Madison Street, Suite 500, ALEXANDRIA, VA, 22314, US

(73) Assignee: PIONEER CORPORATION, Tokyo (JP)

(21) Appl. No.: 12/278,416

(22) PCT Filed: Feb. 6, 2007
(86) PCT No.: PCT/JP2007/051989

§ 371 Date: Oct. 6, 2008

(30) Foreign Application Priority Data
Feb. 10, 2006 (JP) 2006-034443

(51) Int. Cl. G11B 7/00

(52) U.S. Cl. 369/100; G9B/7

(57) ABSTRACT

An optical disc driving apparatus (300) comprises a complementing means (302), an interleaving means (303), and an emission means (304). The complementing means (302) adds complementary data having a predetermined size to the head of reverse-interleaved data (D002 and D003) obtained by reverse-interleaving drawing data (D001) for drawing an image onto an optical disc (400). The interleaving means (303) generates interleaved data (D005) by interleaving reverse-interleaved data (D004) to which the complementary data is added. The emission means (304) emits laser light according to the interleaved data (D005) thus generated.

### TECHNICAL FIELD

The present invention relates to an optical disk driving apparatus and method, which can record data for general recording with respect to an optical disk and can draw an image on the optical disk for example, and an optical disk recording apparatus having such a driving apparatus.

### BACKGROUND ART

As this kind of the recording apparatus, there is an apparatus which forms (or prints) a character etc., by irradiating a laser beam onto a desired area of a label surface of the optical disk and changing a developed color of the irradiated portion. By such a kind of recording apparatus, it is required to set the optical disk upside down so as to make the label surface of the optical disk be irradiated by the laser beam.

To cope with this kind of inconvenience, an optical disk recording apparatus to form a visible image in a discoloration layer of the optical disk by irradiating the laser beam corresponding to visible information in case of recording the visible information with respect to the label surface of the optical disc for example, is proposed (refer to Patent document 1). According to this optical disk recording apparatus, there is a merit to omit turning upside down the optical disk in recording the visible information onto the label surface.

Patent document 1: Japanese Patent Application Laid Open NO. 2004-5846

### DISCLOSURE OF INVENTION

### Subject to be Solved by the Invention

However, according to the technique disclosed by the abovementioned the patent document 1 for example, there is such a possibility that the visible information cannot be truly reconstructed, because the visible information is encoded (or interleaved) as it is and is supplied to a laser driver, after the visible information received from a host PC (Personal Computer), is stored in a buffer memory.

The present invention is prosecuted in view of the above problem for example, and has an object to provide an optical disk driving apparatus and an optical disk driving method, which can enhance the accuracy to draw an image onto an optical disk on the basis of a drawing image data, for example, and an optical disk recording apparatus having such a driving apparatus.

### Means for Solving the Subject

(Optical Disk Driving Apparatus)

The above object of the present invention can be achieved by an optical disk driving apparatus provided with: a complement device for adding a complement data in a predetermined size, to a head position of a reverse-interleave data in which a drawing image data for drawing image on the optical disk is reverse-interleaved; an interleave device for generating an interleave data by interleaving the reverse-interleave data to which the complement data is added; and an emitting device for emitting a laser beam on the basis of the generated interleave data.

According to the optical disk driving apparatus of the present invention, for example, the reverse-interleave data in which the drawing image data is reverse-interleaved, is inputted from an external apparatus such as a host application apparatus to the optical disk driving apparatus, in drawing the image such as Label Flash, onto the optical disk. Then the reverse-interleave data is stored in a buffer built-in the optical disk driving apparatus. On this occasion, by the complement device comprising a controller, for example, the complement data in the predetermined size is added to the head position of the reverse-interleave data inputted or stored. The “reverse-interleave (i.e., de-interleave)” herein means a reverse process of interleave forming a counterpart to “interleave” which is sector assigning process of assigning sector or sectors for realizing fast access. The “reverse-interleave” is useful in the case that a processing speed of bus, CPU (Central Processing Unit) or memory is extremely slow compared to a processing speed of the optical disk driving apparatus. The “complement data in a predetermined size” herein means data having the size and the content which are necessary to properly interleave the reverse-interleave data transmitted from a host application apparatus, especially. This necessary data size of the complement data is defined on the basis of an influence extent of interleave. The content of the complement data is defined on the basis that the drawing image data is used for drawing any image, in other words, there is high possibility to resemble for neighboring or adjacent data.

The reverse-interleave data, to which the complement data in the predetermined size is added, is interleaved by the interleave device comprising an encoder, for example, and the interleave data is generated. The “interleave” of the present invention herein means a process of generating of the interleave data to reproduced an original drawing image data from the reverse-interleave data as faithfully as possible. However, the “interleave” of the present invention means a same process as a general interleave in the case that the optical disk driving apparatus does not record the drawing image data but records the general data for recording. That is to say, the “interleave” of the present invention is not different from the general interleave in its process but perform a special process, as result, on the basis of the abovementioned special structure of an object data of processing in drawing based on the drawing image data. It can be said a fact that the interleave process is not different from a process in general recording in its self, as abovementioned causes distinguished effect in which the present invention can be realized easily.

There is a possibility not to perform the interleave process on the head position of the sector in the case that the complement data is not added to the head position of the sector of the reverse-interleave data. Because it is generally required an object sector of interleave among the reverse-interleave data in performing the abovementioned interleave as well as a front sector of the object sector. On the contrary, according to the present invention, it is possible to generate relatively and extremely precise interleave data by performing the interleave process properly, because the complement data is added to the head position of the reverse-interleave data by the complement device.

The laser beam is emitted on the basis of the generated interleave data, which is relatively and extremely precise, by the emitting device comprising laser driver, for example. By this, the image corresponding to the drawing image data is drawn on the optical disk. Typically, the laser beam is emitted along circumference of the optical disk.

As a result, according to the optical disk driving apparatus of the present invention, it is possible to enhance the precision of drawing the image on the optical disk on the basis of the drawing image data, for example. Specifically, it is possible to draw the image on the optical disk more precisely by using the interleave data which is more similar to the original drawing image data as compared with the case that Null data is added as the complement data, because the data having the proper size and the proper content is added as the complement data by making the best use of being the drawing image data. In addition to this, it is not necessary to change the interleave process in itself, therefore the present invention has great advantage in practice.

In one aspect of the optical disk driving apparatus of the present invention, the optical disk driving apparatus is further provided with: a controlling device for controlling said emitting device to delay a timing of emitting the laser beam by a time amount which corresponds to the predetermined size.

According to this aspect, unintentional drawing might be performed by drawing the complement data in the predetermined size which is added excessively in the case that the timing of emitting the laser beam is not changed by the emitting device. On the contrary, according to this aspect, the laser beam is emitted by the emitting device in delaying the timing of emitting the laser beam by time amount which corresponds to the predetermined size, under the control of the controlling device comprising controller, for example. Therefore, it is possible to prevent drawing the complement data in the predetermined size which is added excessively.

In another aspect of the optical disk driving apparatus of the present invention, sector number per a circle of the optical disk is “n” (n is an integer and is greater than or equal to zero) and, the complement device adds the complement data in an amount of two sectors of to the head position of the reverse-interleave data.

According to this aspect, the abovementioned sector number per a circle of the optical disk is “n” (besides “n” is an integer and is greater than or equal to zero). Then one sector occupies 4 degrees among a circle of the optical disk in the case that “n” is 90, in the other words there are 90 sectors per a circle of the optical disk. This 4 degree is calculated by dividing 360 degree by 90. Here, an influence extent of the interleave process between the sectors, which means sector number or sector extent required to perform the interleave process onto the reverse-interleave data of a specified sector, is 108 EFM frame, because one sector is 98 EFM frame, in the typical interleave process. Therefore 2 sectors of the reverse-interleave data, which position is front of the specified sector, is required to perform the interleave process onto the reverse-interleave data of the specified sector, because “2” is the smallest integer among the actual number which is bigger than “1.1”. The “1.1” is calculated by dividing 108 by 98. For example, the reverse-interleave data of the first sector and the second sector is required to perform the interleave process of the reverse-interleave data of the third sector counting from the front position among the reverse-interleave data. The interleave process of the reverse-interleave data of the third sector can be successfully performed without trouble, because there is the reverse-interleave data of the first sector and the second sector. However, there is no the reverse-interleave data for performing the interleave process of the reverse-interleave data of the first sector and the second sector. On the contrary, the complement device adds two sectors of the complement data to the head position of the abovementioned reverse-interleave data. In other words, the zero-th sector and the “n−1”-th sector which are imaginary sectors, are added in front of the first sector. As a result, it is possible to perform the interleave process of the reverse-interleave data of the first sector and the second sector. Besides, the sector number required for performing the interleave process might be different based on differences of method of the interleave process, as describe as above. For example, one sector amount of the complement data might be added in method of the interleave process in which 1 sector of the reverse-interleave data is required to perform the interleave process onto the reverse-interleave data of the specified sector.

In an aspect associated with adding two sectors of the complement data, the complement device adds same data as the first sector of the reverse-interleave data to the head position of the reverse-interleave data, as the complement data.

According to this aspect, the same data as the first sector of the reverse-interleave data is added to the head position of the reverse-interleave data, as the complement data, by the complement device. That is to say, the same data as the first sector of the reverse-interleave data is added by two sectors amount to the head position of the reverse-interleave data. In other words, the same data as the first sector is respectively added to the zero-th sector and the “−1”-th sector which are imaginary sectors added in front of the first sector. Because it is estimated that adjacent sectors of the drawing image data are similar, in case that the drawing image data is for picture. It is possible to properly perform the interleave process onto the reverse-interleave data of the first sector or the second sector on the basis of two sectors amount of the complement data, which are same data as the first sector of the reverse-interleave data.

Probably, in an aspect associated with adding two sectors of the complement data, the complement device adds same data as the “n−1”-th sector and the “n”-th sector of the reverse-interleave data to the head position of the reverse-interleave data, as the complement data.

According to this aspect, the same data as the “n−1”-th sector and the “n”-th sector of the reverse-interleave data is added to the head position of the reverse-interleave data, as the complement data by the complement device. That is to say, the same data as the “n−1”-th sector and the “n”-th sector of the reverse-interleave data is added by two sectors amount to the head position of the reverse-interleave data. In other words, the same data as the “n−1”-th sector is added to the “−1”-th sector which is imaginary sector and the same data as the “n”-th sector is added to the zero-th sector which is imaginary sector. Because it is estimated that adjacent sectors of the drawing image data are similar, in the case that the drawing image data is for picture and that the first sector and “n”-th sector are adjacent if sector number per a circle of the optical disk is “n”, while the laser beam is typically emitted along circumference of the optical disk. Besides, the complement data to be added, might be properly changed in the case that the sector number required for performing the interleave process is except “2”. For example, the same data as the “n−2”-th sector, “n−1”-th sector and “n”-th sector of the reverse-interleave data is added as the abovementioned complement data in the case that the sector number required for performing the interleave process is “3”.

(Optical Disk Recording Apparatus)

The above object of the present invention can be achieved by an optical disk recording apparatus provided with: the above described optical disk driving apparatus of the present invention (including its various aspects); and a host application device for transmitting the reverse-interleave data to the optical disk driving apparatus.

According to the optical disk recording apparatus of the present invention, by providing the abovementioned optical disk driving apparatus, it is possible to enhance the precision of drawing the image on the optical disk on the basis of the drawing image data, for example.

In one aspect of the optical disk recording apparatus of the present invention, the host application device transmits a command for instructing to add the complement data upon transmitting the reverse-interleave data to the optical disk driving apparatus, and the complement device receives the command and adds the complement data.

According to this aspect, after the command for instructing to add the complement data is received from the host application device, the complement data is added to the reverse-interleave data corresponding to the command by the complement device. The interleave process is performed onto the reverse-interleave data to which the complement data is added. On the other side, the interleave process is performed onto the general data for recording, which is transmitted apart from the reverse-interleave data, without adding the complement data, in the case that the command is not received. Therefore, it is possible to surely enhance the precision of drawing the image on the optical disk on the basis of the drawing image data in drawing.

(Optical Disk Driving Method)

The above object of the present invention can be also achieved by an optical disk driving method provided with: a complement process of adding a complement data in a predetermined size to a head position of a reverse-interleave data in which a drawing image data for drawing image on the optical disk is reverse-interleaved; an interleave process of generating an interleave data by interleaving the reverse-interleave data to which the complement data is added; and an emitting process of emitting a laser beam on the basis of the generated interleave data.

According to the optical disk driving method of the present invention, as same as the abovementioned optical disk driving apparatus, it is possible to enhance precision of drawing the image on the optical disk on the basis of the drawing image data, for example.

Incidentally, in response to the various aspects owned by the abovementioned optical disk driving apparatus of the present invention, the optical disk driving method of the present invention can employ various aspects.

As explained above, according to the optical disk driving apparatus of the present invention, it is provided with: the complement device, the interleave device and the emitting device. According to the optical disk recording apparatus of the present invention, it is provided with: the optical disk driving apparatus and the host application device. According to the optical disk driving method of the present invention, it is provided with: the complement process, the interleave process and the emitting process. Consequently, it is possible to enhance the precision of drawing the image on the optical disk on the basis of the drawing image data, for example.

These effects and other advantages of the present invention will become more apparent from the embodiments explained below.

### BRIEF DESCRIPTION OF DRAWINGS

FIG. 1 is a block diagram conceptually showing the basic structure of an optical disk recording apparatus having an optical disk driving apparatus in a first embodiment of the present invention.

FIG. 2 is a flowchart showing the operational process of the optical disk driving apparatus in the first embodiment.

FIG. 3 is a schematic diagram conceptually showing the basic structure of the reverse-interleave data to which the complement data in a predetermined size is added, in the first embodiment.

FIG. 4 is a flowchart showing the operational process of the optical disk driving apparatus in a second embodiment.

FIG. 5 is a schematic diagram conceptually showing the basic structure of the reverse-interleave data to which the complement data in the predetermined size is added, in the second embodiment.

### DESCRIPTION OF REFERENCE CODES

1 optical disk recording apparatus
200 host application device
201 buffer
202 reverse-interleave device
300 driving apparatus
301 buffer
302 complement device
303 interleave device
304 emitting device
305 controller
D001 drawing image data
D002 reverse-interleave (i.e., de-interleave) data
D003 reverse-interleave data
D004 reverse-interleave data to which complement data in the predetermined size is added
D005 interleave data
400 optical disk
401 first sector area
402 second sector area
403 third sector area
40 nm1 “n−1”-th sector area
40n “n”-th sector area
40np1 “n+1”-th sector area
40np2 “n+2”-th sector area
D0041 reverse-interleave data to which the complement data in the predetermined size is added in the first embodiment
D0042 reverse-interleave data to which the complement data in the predetermined size is added in the second embodiment

### BEST MODE FOR CARRYING OUT THE INVENTION

Hereinafter, the best mode for carrying out the present invention will be discussed in order for each embodiment, with reference to the drawings.

### (1) The First Embodiment

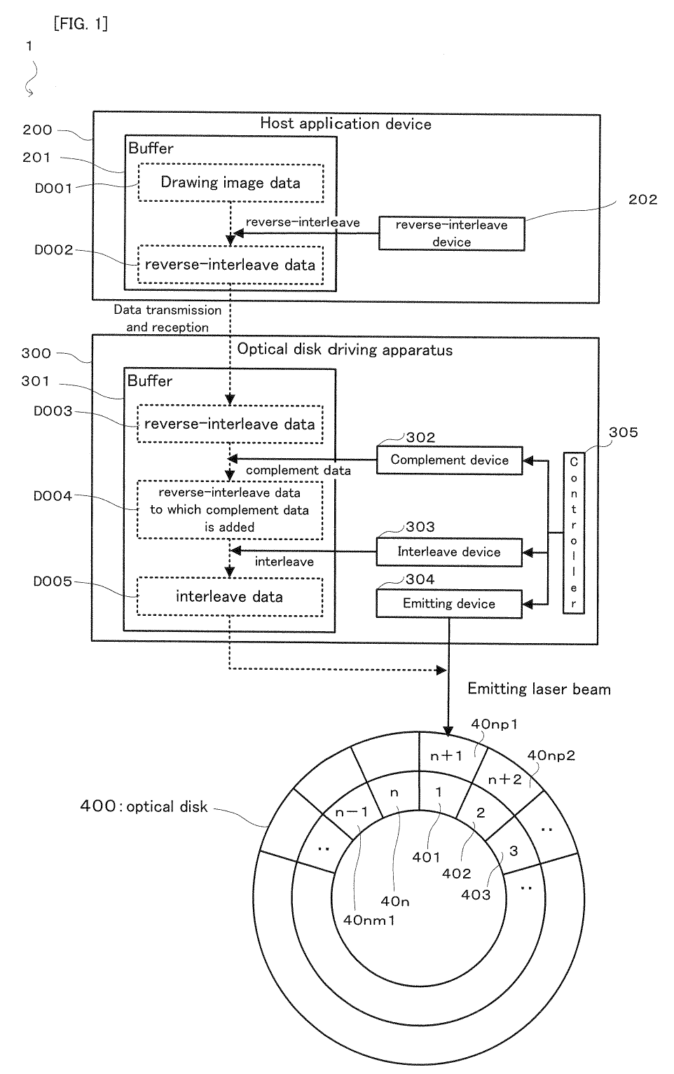

With reference to FIG. 1 to FIG. 3, a structure and an operational process of an optical disk driving apparatus in a first embodiment of the present invention will be discussed.

(1-1) Basic Structure

Firstly, with reference to FIG. 1, the basic structure of an optical disk recording apparatus including an optical disk driving apparatus in the embodiment will be explained. FIG. 1 is a block diagram conceptually showing the basic structure of the optical disk recording apparatus including the optical disk driving apparatus in the first embodiment of the present invention.

As shown in FIG. 1, the optical disk recording apparatus 1 in the first embodiment constitutes one example of the “optical disk recording apparatus” of the present invention. The optical disk recording apparatus 1 is provided with: a host application device 200, which constitutes one example of the “host application device” of the present invention, and an optical disk driving apparatus 300, which constitutes one example of the “optical disk driving apparatus” of the present invention. The optical disk recording apparatus 1 is constituted to be able to draw the image such as Label Flash on an optical disk 400.

The host application device 200 is a host PC (Personal Computer), for example and is constituted to contain a buffer 201 and a reverse-interleave device 202 which will be explained below.

The buffer 201 is a buffer memory, for example and stores various kinds of data to be transmitted to the optical disk driving apparatus 300. The various kinds of data may contain a drawing image data D001 and a reverse-interleave data D002.

The drawing image data D001 is data for drawing a mark or a character such as a name of music, for example. The drawing image data D001 is automatically generated by the host application device 200 or by receiving an instruction of user.

The reverse-interleave data D002 (i.e., the de-interleave or de-interleaved data D002) is data generated by performing the reverse-interleave process (i.e., the “de-interleave” process) onto the drawing image data D001 by the reverse-interleave device 202.

The reverse-interleave device 202 includes an operation circuit, for example and generates the reverse-interleave data D002 by performing the reverse-interleave process onto the drawing image data D001, as the sector assigning process of assigning sector or sectors for realizing fast access. The generated reverse-interleave data D002 is transmitted from the host application device 200 to the optical disk driving apparatus 300 through a bus, in addition to the command such as a “Write 12” command for instructing to add the complement data.

The optical disk driving apparatus 300 is apparatus for recording onto an optical disk such as CD (Compact Disc), DVD or BD (Blu-ray Disc). The optical disk driving apparatus 300 is constituted to contain a buffer 301, a complement device 302, an interleave device 303, an emitting device 304 and a controller 305 which will be explained below. The optical disk driving apparatus 300 draw an image on the optical disk 400 on the basis of the reverse-interleave data D002 transmitted from the host application device 200.

The buffer 301 is a buffer memory, for example and stores the various kinds of data which contain the reverse-interleave data D003, the reverse-interleave data D004, to which the predetermined size of the complement data (i.e., the complement data in the predetermined size) is added, and the interleave data D005.

The reverse-interleave data D003 is data which is stored or accumulated after receiving the reverse-interleave data D002 transmitted from the host application apparatus 200. The content of the reverse-interleave data D003 is same as the reverse-interleave data D002.

The complement device 302 constitutes one example of the “complement device” of the present invention and includes an operation circuit, for example and generates the reverse-interleave data D004 to which the predetermined size of the complement data is added, by adding the predetermined size of the complement data to the reverse-interleave data D003, to complement a shortage of data in performing the interleave process onto the reverse-interleave data D003, after receiving the command for instructing to add the complement data. The data size of the complement data is defined on the basis of the influence extent of the interleave or interleave process. The content of the complement data may be defined in consideration with the fact that the drawing image data is used for drawing any image, in other words, there is high possibility that the image data resembles for neighboring or adjacent data.

The reverse-interleave data D004, to which the predetermined size of the complement data is added, is data generated by the above-mentioned complement device 302. The detail of the reverse-interleave data D004 will be explained below by using FIG. 3 and FIG. 5.

The interleave device 303 constitutes one example of the “interleave device” of the present invention and is constituted to contain an encoder, for example and generates the interleave data D005 by performing the interleave process onto the reverse-interleave data D004 to which the predetermined size of the complement data is added.

The interleave data D005 is data generated by the above-mentioned the interleave device 303. The emitting device 304 finally emits the laser beam on the basis of this interleave data D005. This interleave data D005 makes the original drawing image data be recovered and drawn more truly to extreme degrees, by virtue of the compliment data added by the compliment device 302, as compared with such a case that Null data is merely added as the complement data, for example.

The emitting device 304 constitutes one example of the “emitting device” of the present invention and is constituted to contain a laser driver (not illustrated) and a laser diode (not illustrated), for example and makes the laser diode emit the laser beam to draw the image on the optical disk 400, after the laser driver supplies the laser diode with a driving current based on the interleave data D005.

The controller 305 constitutes one example of the “controlling device” of the present invention and is constituted to contain CPU (not illustrated) and a memory (not illustrated), for example and, in order to prevent the predetermined size of the complement data which is excessively added from being drawn as image, makes the emitting device 304 delay the timing of emitting the laser beam by the time amount which corresponds to the above mentioned predetermined size.

The optical disk 400 is CD, DVD or BD (Blu-ray Disc), for example. The emitting device 304 typically emits the laser beam along the circumference of the optical disk 400. Specifically, if the sector number per one circle of the optical disk is “n”, the laser beam is emitted to the first sector area 401, the second sector area 402, . . . the “n−1”-th sector area 40nm1 and “n”-th sector area 40n as the first lap, along the circumference of the optical disk 400 in sequence. Next, as the second lap, the laser beam is emitted to the “n+1”-th sector area 40np1, the “n+2”-th sector area 40np2, . . . in sequence, after an emitting position is shifted toward the outer circumference side. Here, the first sector area 401, . . . , the “n+2”-th sector area 40np2 are respectively areas on the optical disk 400 of the first sector, . . . , the “n+2”-th sector of the interleave data D005 which becomes basis in emitting the laser beam.

Incidentally, if the command such as the “Write 12” command for instructing to add the complement data is not received, the interleave process is performed onto the general data for recording, which is transmitted apart from the reverse-interleave data D002 from the host application apparatus 200, for example, without adding the complement data by the abovementioned complement device 302. Then a general recording is performed by the emitting device 304.

Consequently, according to the structure shown by FIG. 1, it is possible to enhance the precision of drawing the image on the optical disk on the basis of the drawing image data.

(1-2) Operational Process

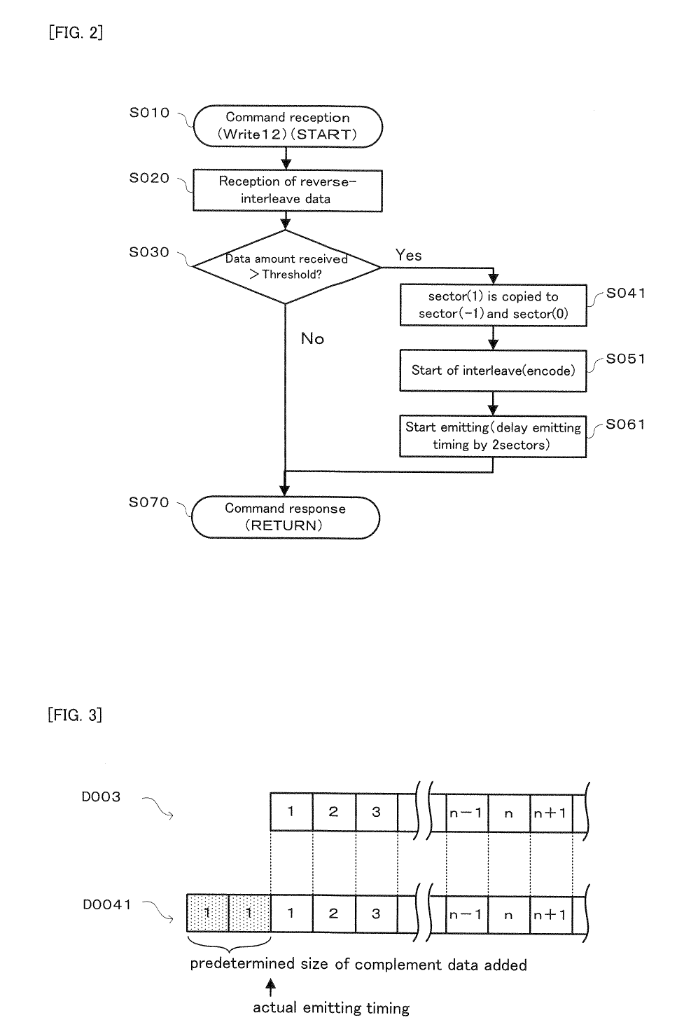

Next, with reference to FIG. 2 and FIG. 3 in addition to FIG. 1, an explanation will be given on the operational process of the optical disk driving apparatus which is constituted as described above, in the embodiment. FIG. 2 is a flowchart showing the operational process of the optical disk driving apparatus in the first embodiment. FIG. 3 is a schematic diagram conceptually showing the basic structure of the reverse-interleave data to which the predetermined size of the complement data is added, in the first embodiment. Incidentally, in FIG. 3, the same elements carry the same numerical references, and the explanation thereof will be omitted.

As shown in FIG. 2, at first, the optical disk driving apparatus 300 receives the “Write 12” command transmitted from the host application device 200, upon drawing the image such as Label Flash on the optical disk 400 (step solo).

Then, since the reverse-interleave data D002 is transmitted in a group of 32 sectors from the host application apparatus 200, the optical disk driving apparatus 300 receives this data and stores it into the buffer 301 as the reverse-interleave data D003 (step S020).

Simultaneously with this or in tandem with this, it is judged whether or not a data amount of the reverse-interleave data D003 received and stored exceeds a predetermined threshold by the controller 305 (step S030). This predetermined threshold may be set as a value, which is bigger than a data amount necessary for performing the interleave process later on, by an experiment or by using simulation method, beforehand.

Here, if it is judged that the data amount of reverse-interleave data D003 does not exceed the predetermined threshold (step S030: No), a condition of the optical disk driving apparatus 300 goes back to a command response condition and the optical disk driving apparatus 300 waits to receive remaining data from the host application device 200 (step S070).

On the other side, if it is judged that the data amount of reverse-interleave data D003 exceeds the predetermined threshold (step S030: Yes), the complement device 302 generates the reverse-interleave data D004 to which the predetermined size of the complement data is added, by adding the predetermined size of the complement data to the reverse-interleave data D003. More concretely, the first sector of the reverse-interleave data D003 is copied to the “n−1”-th sector and the “zero”-th sector by the complement device 302, wherein the first sector is referred to the reverse-interleave data D003 in FIG. 3 (step S041). Consequently, the same data as the first sector is added to the head position of the reverse-interleave data D003, as the predetermined size of the complement data, by 2 sectors amount. Then the reverse-interleave data D004 to which the predetermined size of the complement data is added, becomes to be generated. (refer to “the predetermined size of the complement data added” in the reverse-interleave data D0041 to which the predetermined size of the complement data is added in FIG. 3.).

The interleave process (or encode process) is performed onto the reverse-interleave data D0041 to which the predetermined size of the complement data is added, by the interleave device 303. Then the interleave data D005 is generated and stored in the buffer 301 (step S051).

The emitting device 304 emits the laser beam on the basis of this interleave data D0055 to draw the image on the optical disk 400 (step S061). On this occasion, the controller 305 makes the emitting device 304 delay the timing of emitting the laser beam by the time amount which corresponds to 2 sectors of the predetermined size of the complement data. (refer to an “actual emitting timing” in the reverse-interleave data D0041 to which the predetermined size of the complement data is added in FIG. 3.) Consequently, the image is drawn on the optical disk 400 without causing any inconsistency between the original drawing image data D001 and the predetermined size of the complement data added, and then the condition of the optical disk driving apparatus 300 goes back to the command response condition to draw following image on the optical disk 400.

Consequently, as explaining by referring FIG. 1 to FIG. 3, according to the first embodiment, it is possible to enhance the precision of drawing the image on the optical disk 400 on the basis of the drawing image data D001 in the optical disk driving apparatus 300. Especially, it is possible to properly interleave the reverse-interleave data of the first sector or the second sector, because the complement data by 2 sectors amount is added. In addition to this, it is possible to enhance the precision of drawing the image by using such a feature of the drawing image data that adjacent sectors of the drawing image data are similar, because the content of the complement data is same as the content of the first sector.

### (2) The Second Embodiment

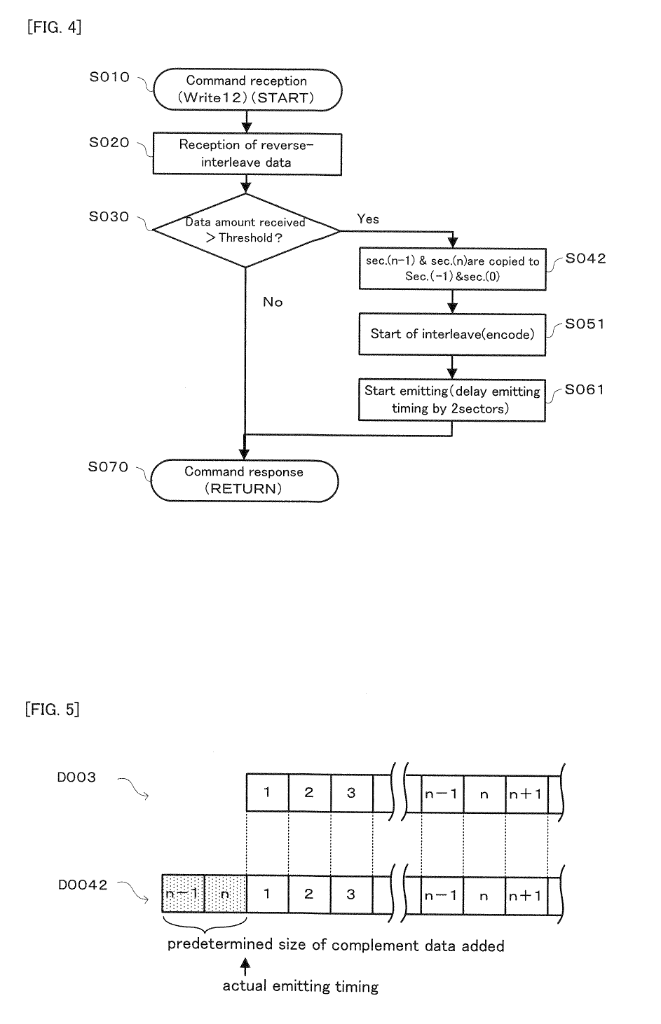

Next, with reference to FIG. 4 and FIG. 5 in addition to FIG. 1 to FIG. 3, a structure and an operational process of an optical disk driving apparatus in a second embodiment of the present invention will be discussed in detail.

(2-1) Basic Structure

Firstly, the basic structure of an optical disk recording apparatus having an optical disk driving apparatus in the second embodiment is same as the basic structure of an optical disk recording apparatus having an optical disk driving apparatus in the first embodiment. Therefore the explanation thereof will be omitted by using FIG. 1.

(2-2) Operational Process

Next, with reference to FIG. 4 and FIG. 5 in addition to FIG. 1 to FIG. 3, an explanation will be given on the operational process of the optical disk driving apparatus which is constituted as described above, in the second embodiment. FIG. 4 is a flowchart showing the operational process of the optical disk driving apparatus in the second embodiment. FIG. 5 is a schematic diagram conceptually showing the basic structure of the reverse-interleave data to which the predetermined size of the complement data is added, in the second embodiment. Incidentally, in FIG. 4 and FIG. 5, the same processes or the same elements as those in FIG. 2 and FIG. 3 carry the same numerical references, and the explanation thereof will be omitted.

The difference between FIG. 4 and FIG. 2 is performing a process of the step S042 in FIG. 4 instead of the process of the step S041 in FIG. 2. In addition to this, the difference between FIG. 5 and FIG. 3 is a content of the predetermined size of the complement data added by the complement device 302. Owing to this difference, “the reverse-interleave data D0042 to which the predetermined size of the complement data is added” is adopted in stead of “the reverse-interleave data D0041 to which the predetermined size of the complement data is added”.

Specifically, in FIG. 4, if it is judged that the data amount of reverse-interleave data D003 exceeds the predetermined threshold (step S030: Yes), the “n−1”-th sector and the “n”-th sector of the reverse-interleave data D003 are copied to the “−1”-th sector and the “zero”-th sector respectively by the complement device 302 (step S042). Consequently, the same data as the “n−1”-th sector and the “n”-th sector is added to the head position of the reverse-interleave data D003, as the predetermined size of the complement data, by 2 sectors amount. Thus, the reverse-interleave data D004 to which the predetermined size of the complement data is added, becomes to be generated. (refer to “the predetermined size of the complement data added” in the reverse-interleave data D0042 to which the predetermined size of the complement data is added in FIG. 5.)

As explained above with referring FIG. 4 and FIG. 5 in addition to FIG. 1 to FIG. 3, according to the second embodiment, it is possible to enhance the precision of drawing the image on the optical disk 400 on the basis of the drawing image data D001 in the optical disk driving apparatus 300. Especially, if the sector number per a circle of the optical disk is “n”, it is possible to enhance the precision of drawing the image by using such a feature that the first sector and the “n”-th sector are adjacent.

The structure and the operational process of the optical disk driving apparatus shown by the aforementioned each embodiment, might be put into practice by the optical disk recording apparatus including the optical disk driving apparatus. Alternatively, the structure and the operational process might be put into practice by operating the optical disk recording apparatus on the basis of the optical disk driving method including the complement process, the interleave process and the emitting process.

The present invention is not limited to the aforementioned embodiments, and various changes may be made, if desired, without departing from the essence or spirit of the invention which can be read from the claims and the entire specification. An optical disk driving apparatus, an optical disk driving method and an optical disk recording apparatus comprising the optical disk driving apparatus, all of which involve such changes, are also intended to be within the technical scope of the present invention.

### INDUSTRIAL APPLICABILITY

The optical disk driving apparatus, the optical disk driving method and the optical disk recording apparatus of the present invention can be applied to an optical disk driving apparatus on which an image can be recorded on an optical disk, for example, in addition to that a data for general recording can be recorded on the optical disk, for example, and can be further applied to an optical disk recording apparatus including the optical disk driving apparatus.

1. An optical disk driving apparatus comprising:
a complement device for adding a complement data in a predetermined size, to a head position of a reverse-interleave data in which a drawing image data for drawing image on the optical disk is reverse-interleaved;
an interleave device for generating an interleave data by interleaving the reverse-interleave data to which the complement data is added; and
an emitting device for emitting a laser beam on the basis of the generated interleave data.

2. The optical disk driving apparatus according to claim 1, further comprising a controlling device for controlling said emitting device to delay a timing of emitting the laser beam by a time amount which corresponds to the predetermined size.

3. The optical disk driving apparatus according to claim 1, wherein
sector number per a circle of the optical disk is “n” (n is an integer and is greater than or equal to zero), and
said complement device adds the complement data in an amount of two sectors to the head position of the reverse-interleave data.

4. The optical disk driving apparatus according to claim 3, wherein said complement device adds same data as the first sector of the reverse-interleave data to the head position of the reverse-interleave data, as the complement data.

5. The optical disk driving apparatus according to claim 3, wherein said complement device adds same data as the “n−1”-th sector and the “n”-th sector of the reverse-interleave data to the head position of the reverse-interleave data, as the complement data.

6. An optical disk recording apparatus comprising:
the optical disk driving apparatus according to claim 1; and
a host application device for transmitting the reverse-interleave data to the optical disk driving apparatus.

7. The optical disk recording apparatus according to claim 6, wherein
said host application device transmits a command for instructing to add the complement data upon transmitting the reverse-interleave data to the optical disk driving apparatus, and
said complement device receives the command and adds the complement data.

8. An optical disk driving method comprising:
a complement process of adding a complement data in a predetermined size to a head position of a reverse-interleave data in which a drawing image data for drawing image on the optical disk is reverse-interleaved;
an interleave process of generating an interleave data by interleaving the reverse-interleave data to which the complement data is added; and
an emitting process of emitting a laser beam on the basis of the generated interleave data.
